(19) United States
(12) Patent Application Publication
(10) Pub. No.: US 2022/0379276 A1
(43) Pub. Date: Dec. 1, 2022

(54) DEVICE AND METHOD FOR PRODUCING AND TRANSPORTING DRY ICE PELLETS

(71) Applicant: Messer Group GmbH, Bad Soden (DE)

(72) Inventor: Jean-Claude Claeys, Zwijndrecht (BE)

(73) Assignee: Messer Group GmbH, Bad Soden (DE)

(21) Appl. No.: 17/770,342

(22) PCT Filed: Oct. 22, 2020
(86) PCT No.: PCT/EP2020/079807

§ 371 Date: Apr. 20, 2022

(30) Foreign Application Priority Data
Oct. 25, 2019 (DE) 10 2019 007 439.4

(51) Int. Cl. B01J 2/20; C01B 32/55

(52) U.S. Cl. CPC B01J 2/20; C01B 32/55

(57) ABSTRACT

A device for producing dry ice pellets comprises a pressing cylinder, into which an inlet opening for feeding liquid carbon dioxide leads and which is equipped with a die, which has one or more openings, and with a piston, which is longitudinally movable in the pressing cylinder. Liquid carbon dioxide is fed to the pressing cylinder, is expanded at the inlet opening, is at least partially converted into carbon dioxide snow and is pressed against and through the die by the movement of the piston. The die is in the form of a cylindrical body that can be connected to the pressing cylinder and is equipped with feed-throughs, which are oriented parallel to a longitudinal axis of the die and are dimensioned in such a way that the length and the diameters of the feed-throughs correspond to the length and the diameters of the dry ice pellets to be produced.

### CROSS-REFERENCE TO RELATED APPLICATIONS

This application is the U.S. national stage application of International Application No. PCT/EP2020/079807, filed Oct. 22, 2020, which International Application was published on Apr. 29, 2021, as International Publication WO 2021/078891 A1 in the German language. The International Application claims priority to German Application No. 10 2019 007 439.4, filed Oct. 25, 2019. The International Application and German Application are hereby incorporated herein by reference, in their entireties.

### FIELD

The invention relates to a device for producing and transporting dry ice pellets.

### BACKGROUND

In the following, “dry ice pellets” or “carbon dioxide pellets” are to be understood as hard parts composed of solid carbon dioxide, which have been produced by pressing carbon dioxide snow or by freezing liquid carbon dioxide. Dry ice pellets serve various purposes, for example they can be used to blast surfaces for cleaning purposes or to cool products.

Devices for the production of dry ice pellets are known, which devices have a pressing cylinder comprising a movable piston, a feed opening for feeding carbon dioxide into the pressing cylinder, and a die, which is on the side of the pressing cylinder and equipped with one or more holes and against which the piston presses the carbon dioxide. The carbon dioxide, which is usually supplied in liquid form, expands as it enters the pressing piston, partially forming carbon dioxide snow. This is pressed against and through the holes of the die by the propulsion of the piston. Gas produced as the carbon dioxide is being supplied is discharged via an exhaust pipe. Devices of this type are known, for example, from EP 1 328 765 B1, US 2012/0291479 A1 or DE10 2008 027 283 A1. The dry ice strands exiting the die break into pieces of irregular length as they exit the die or are cut into pieces by means of suitable cutting tools. The fragments are collected in containers in which they are transported to the place of use, for example a blasting apparatus. A disadvantage of these items is that the length of the pellets is only precisely determined within a certain range of variation and therefore there is some uncertainty about the total amount of dry ice produced.

Known from EP 0707 796 A1 or U.S. Pat. No. 5,413,526 B 1 are apparatuses for internal cooling of tissue parts, in particular pieces of meat, in which dry ice pellets are injected into the tissue to be cooled. The apparatuses used for this purpose each comprise a slit means, by which a pocket is formed in the piece of meat to be cooled, into which a multiplicity of dry ice pellets is subsequently filled. A disadvantage of this item is that the amount of dry ice pellets supplied can only be determined very imprecisely, which in the case of these items can result in undesired inhomogeneous cooling of the product, and thus in an inhomogeneous meat quality.

### SUMMARY

The invention is therefore based on the object of creating a device for producing and transporting dry ice pellets, in which the pellets can be produced in a uniform size and shape and transported to the place of use without risk of breakage.

This object is achieved by a device having the features of claim 1. Advantageous designs of the invention are indicated in the dependent claims.

A device according to the invention for producing and transporting dry ice pellets comprises a pelletizing device, which has a pressing cylinder comprising an inlet for supplying liquid carbon dioxide and a gas outlet for discharging carbon dioxide gas, a piston accommodated in a longitudinally movable manner in the pressing cylinder, and a die arranged at an end of the pressing cylinder and having leadthroughs aligned parallel to a longitudinal axis of the die, wherein the die is separably connected to the pressing cylinder and the leadthroughs of the die correspond in their length and diameter to the length and diameters of dry ice pellets to be produced.

According to the invention, the die functions both as a mold for the dry ice pellets to be produced and as a transport container for them. The dry ice pellets produced in the pelletizing device from compressed carbon dioxide snow have a uniform shape determined by the length and cross-section of the leadthroughs of the die. In addition, the pellets are transported in the die and together with it to the place of use, which ensures safe transport protected from breakage. The pellets remain in the die until they are ejected or pressed out of the die at the point of use by a separate application means. The matrix freed from the carbon dioxide pellets can then be reconnected to the pressing cylinder and loaded with dry ice pellets.

An advantageous further development of the invention provides a separating means for removing any dry ice strands formed during the production of the dies and protruding from the end of the die. The separating means preferably comprises a cutting device which cuts off the dry ice strands flush with the face of the die, thus ensuring pellets whose size corresponds exactly to the dimensions of the leadthroughs. The dry ice strands separated in front of the end of the die may then be collected and brought to another application where an exactly reproducible size and shape of the pellets is less relevant, for example as a blasting or cooling agent. The separating means may be arranged directly on the pressing cylinder and used while the die is still fixed to the pressing cylinder, or alternatively as a separate apparatus to which the die, detached from the pressing cylinder, is brought after the dry ice pellets have been produced. Furthermore, this separating means may also be equipped with means to remove dry ice pellets from leadthroughs in which no dry ice pellets are to be transported.

The die stocked with dry ice pellets preferably serves, in a means for applying dry ice pellets (hereinafter also referred to as “application device”) remote from the pelletizing device, as an exchangeable magazine for carbon dioxide pellets. For this reason, the die preferably has fastening means such as, for example, holes, grooves or pins that act in combination with corresponding means in the application device, or the pressing cylinder, by which it can be mounted as easily as possible in the application device and/or on the pressing cylinder. In the application device, the dry ice pellets are ejected or pressed out by a mechanical action, and supplied to their place of use. In order to ensure the necessary longitudinal mobility of the dry ice pellets within the leadthroughs, it is advantageous to heat the die before it is brought to the application device, for example to bring it to a heating device, or to equip the die with a heating means which ensures that a thin layer of carbon dioxide sublimates on the surface of the dry ice pellets received in the leadthroughs.

In an expedient design of the invention, the leadthroughs are arranged in a rotationally symmetrical manner around a central axis of the die. The die is thus constructed in the shape of a circular cylinder, and the leadthroughs are arranged at equal angular distances from each other and at equal radial distance from a central axis of the die. A die shaped in such a manner may, for example, act in combination with a turret mechanism in an application means, and in particular facilitates the sequential ejection of individual dry ice pellets from the die. A die constructed in such a manner may have, for example, six to twenty, preferably eight to sixteen leadthroughs that can be stocked with dry ice pellets.

In an alternative design, the leadthroughs extending parallel to one another from end to end of the die are arranged in parallel rows that are offset from one another, such that there is as dense an arrangement of leadthroughs as possible within the die. Such a design makes it possible, in particular, to produce a large number of dry ice pellets in one die.

Assigned to the pressing cylinder there is preferably a means for automatically inserting and fixing the die. In this case, there is no need for time-consuming manual exchanging of the dies.

The leadthroughs have a length, for example, of between 30 mm and 150 mm, preferably between 50 mm and 100 mm, and a diameter of between 5 mm and 25 mm, preferably between 5 mm and 15 mm. The dry ice pellets produced in the leadthroughs each have a mass between of 5 g and 100 g, preferably between 10 g and 50 g, and a volume of between 3 cm³ and 50 cm³, with a diameter of between 5 mm and 15 mm. These comparatively large pellets are suitable in particular for uniform chilling of meat products following slaughter.

Preferably, the gas outlet is connected to a means for reliquefying carbon dioxide gas produced in the pressing cylinder upon expansion of liquid carbon dioxide. The reliquefied carbon dioxide may then be used again to produce carbon dioxide pellets in the device according to the invention, or in another process.

The device according to the invention is preferably used in a system for producing, transporting and applying dry ice pellets which, in addition to the device according to the invention, is equipped with a means for applying dry ice pellets (also referred to in short in the following as “application means”), in which the die can be used as a magazine for supplying dry ice pellets. For this purpose, the application means has a magazine receiver into which the die can be inserted, as well as a means by which the dry ice pellets present in the leadthroughs of the die inserted in the magazine receiver are ejected or forced out of the leadthroughs of the die. In an advantageous design, the system further comprises a means for reliquefying the carbon dioxide gas produced in the pelletizing device according to the invention, and/or a separating means of the type described above.

In the operation of the system, dry ice pellets are first produced in the die of a pelletizing device according to the invention. The die loaded with dry ice pellets is then transported to an application means and inserted into the magazine receiver of the application means. The application means ejects the dry ice pellets from the die and simultaneously conveys them to their intended location, for example into a part of a product to be cooled that is intended to receive the dry ice pellets. After the die has been emptied, it is removed from the magazine receiver and can be reloaded with dry ice pellets in the pelletizing device in the manner described above.

The object of the invention is also achieved by a method for producing, transporting and applying dry ice pellets in which dry ice pellets are produced in a die of a pelletizing device, the die stocked with dry ice pellets is then separated from the pelletizing device and brought to a means for applying dry ice pellets (application means), as a magazine for dry ice pellets, and the dry ice pellets are delivered to their intended location by the application means. The method can be used to bring individual dry ice pellets of a precisely determined size to their place of use. For example, the dry ice pellets are supplied by the application means to a product to be cooled; for example, openings corresponding to the size of the dry ice pellets are produced inside a tissue, for instance a piece of meat, into each of which a dry ice pellet is introduced by means of the application means.

### BRIEF DESCRIPTION OF THE DRAWINGS

The invention is now to be explained in greater detail on the basis of the drawings, in which, in schematic views:

FIG. 1 shows the pelletizing device of a device according to the invention, in a longitudinal section,

FIGS. 2 and 3 show exemplary embodiments of dies for devices according to the invention, in a front view,

FIG. 4 shows a system according to the invention for producing, transporting and applying dry ice pellets.

### DETAILED DESCRIPTION

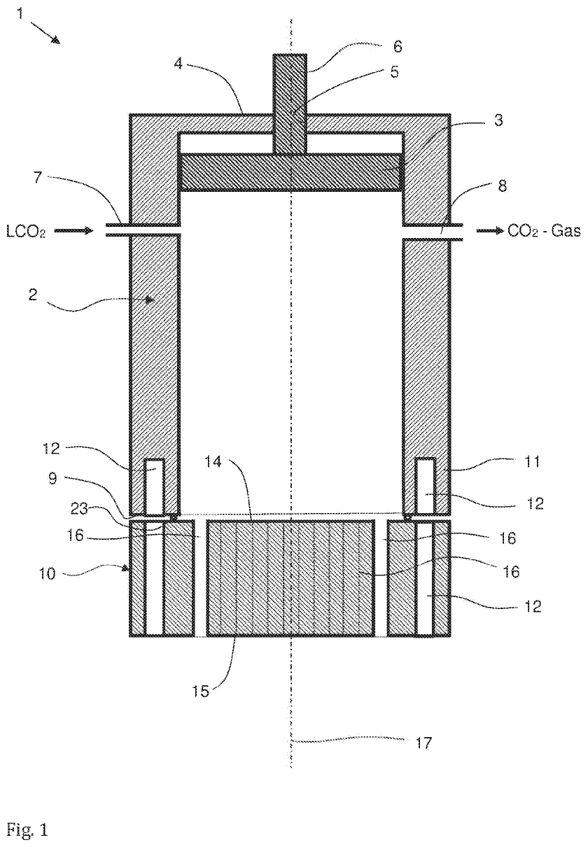

The pelletizing device 1 shown in FIG. 1 comprises, in a manner known per se, a pressure-resistant pressing cylinder 2 in which a piston 3 is received in a longitudinally movable manner. The piston 3 is moved by means of a piston rod 6, which is guided through an opening 5 in a rear end 4 of the pressing cylinder 2 and is connected to a drive, which is not shown here. The pressing cylinder 2 further comprises an inlet 7 for liquid carbon dioxide and a gas outlet 8 for carbon dioxide gas produced upon expansion of the supplied liquid carbon dioxide.

A die 10, described in greater detail below, is arranged on the end 9 of the pressing cylinder 2 that is opposite the rear end 4. For this purpose, arranged in a front portion 11 of the pressing cylinder 2 there are fastening means, for example threaded holes 12, which open out at the end face 9. The threaded holes 12 serve to detachably fasten the die 10 to the pressing cylinder 2 by means of screws, not shown here. In addition, instead of a screw connection, other connecting means may also be used, by means of which the die 10 can be easily mounted on the pressing cylinder 2 and just as easily demounted from it again and, for example replaced by another die.

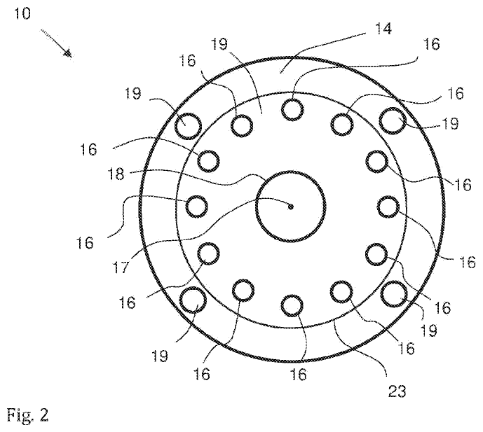

The die 10 is a cylindrical body having an inner end 14 and an outer end face 15 made of a pressure-resistant material such as, for example, stainless steel, within which a number of leadthroughs 16 are provided, which extend parallel to a longitudinal axis 17 of the pressing cylinder 2 and die 10 and—in the exemplary embodiment according to FIG. 2—are arranged at the same radial distance from the longitudinal axis 17 in each case. Depending on the respective application, there may be a central leadthrough 18 (as shown in the exemplary embodiment) or a number of further leadthroughs arranged radially on the inside of the leadthroughs 16; or the die is closed in this region.

The length of the die 10, and thus the length of the leadthroughs 16, as well as the diameters of the leadthroughs 16, are dimensioned such that the dry ice pressed into them during the advance of the piston 3 corresponds in its length and diameter to the dimensions of dry ice pellets to be applied in an application. The dry ice pellets are thus produced inside the die 10 and remain there until they are applied at a place of use. The die 10 is therefore fastened to the pressing cylinder 2 in such a way that it can be easily removed from the pressing cylinder 2 by an operator or by an automatic means and replaced by an empty die 10, i.e. one not stocked with dry ice, and has corresponding connecting means, for example holes 19, that act in combination with the threaded holes 12.

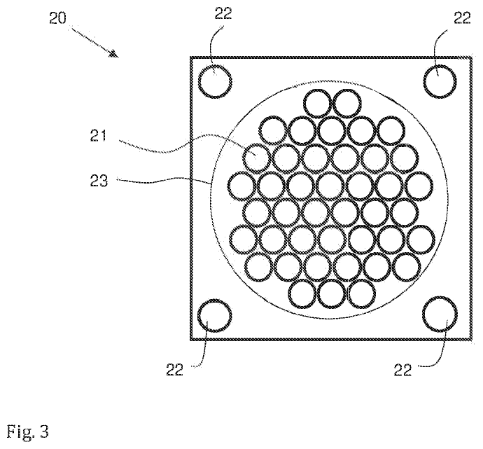

The die 20 shown in FIG. 3 differs from the die 10 substantially in that the leadthroughs 21 are not arranged in a rotationally symmetrically manner about an axis, but are arranged in rows offset from each other to allow the leadthroughs 21 to be arranged as densely as possible, which in turn allows the greatest possible number of dry ice pellets to be produced in a die 20. To fasten the die 20 to a pressing cylinder 2 in the case of the die 20, holes 22 are used, which are arranged to the side of the leadthroughs and at which suitable connecting means, for example screws, not shown here, are screwed into corresponding threads on the front side of the pressing cylinder 2. The holes 22 may at the same time also serve to fasten the die 20 in an application means, for example a means for applying dry ice pellets to a piece of meat. In both exemplary embodiments according to FIG. 2 and FIG. 3, a sealing ring 23 provides a sealing connection to the pressing cylinder 2, which prevents carbon dioxide ice from escaping laterally at the die 10, 20.

In the operation of the pelletizing device 1, a die 10, 20 is first fastened to the pressing cylinder 2. Liquid carbon dioxide is then supplied to the pressing cylinder 2 via the inlet 7. The liquid carbon dioxide expands as it enters the pressing cylinder 2, forming carbon dioxide snow and carbon dioxide gas. While the carbon dioxide snow remains in the pressing cylinder 2, the carbon dioxide gas is discharged via the gas outlet 8. Finally, the inlet 7 and the gas outlet 8 are closed by means of valves, not shown here. Advancing of the piston 3 causes the carbon dioxide snow in the pressing cylinder 2 to be pressed against and into the leadthroughs 16, 18 of the die 10, 20 and thereby compressed to form dry ice. The mass of the carbon dioxide snow present in the pressing cylinder 2 in this case should not, or should only insignificantly exceed, the mass of the dry ice that can be pressed into the leadthroughs 16, 18, such that, after pressing, the piston 3 is as close as possible to the end 14 of the die 10, 20. The piston 3 is then returned to its initial position, as a result of which the interior of the pressing cylinder 2 is relieved of pressure. The die 10, 20 is now demounted, together with the dry ice contained in the leadthroughs 16, 18, and replaced by a new die not stocked with dry ice. Before or after separation from the pressing cylinder 2, the die 10, 20 stocked with dry ice is subjected to a post-treatment in a separating means (not shown in FIGS. 1 to 3), in which any protruding strands of dry ice are cut off and/or individual leadthroughs 16, 18 are completely freed from dry ice. The die 10, 20 thus stocked with dry ice pellets is removed from the pressing cylinder 2 and brought to the place of use of the dry ice pellets.

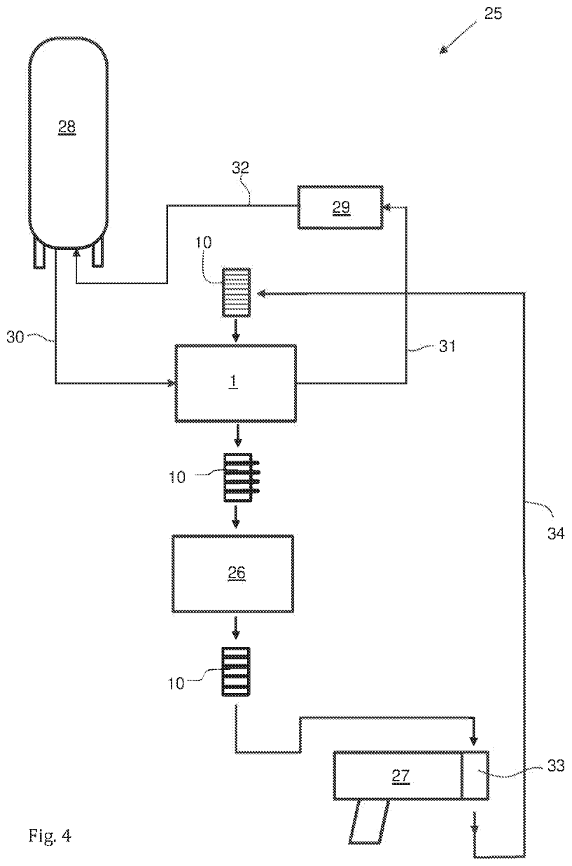

FIG. 4 shows a system 25 for applying dry ice pellets by use of a device according to the invention. In addition to the pelletizing device 1 and a separating means 26 for post-treatment of the die 10, 20, the system 25 comprises an application means 27. Furthermore, the system 25 comprises a tank 28 for pressurized carbon dioxide and a means 29 for reliquefying the carbon dioxide gas produced upon expansion of the liquid carbon dioxide in the pelletizing device 1.

For the purpose of producing dry ice pellets in the manner described above, a die (die 10 in the example shown here) is connected to the pressing cylinder 2 of the pelletizing device 1. Liquid carbon dioxide is then supplied from the tank 28 to the pelletizing device 1 via a feed line 30. The carbon dioxide gas that occurs upon expansion of the liquid carbon dioxide in the pressing cylinder 2 is supplied via a gas line 31 to the means 29, where it is pressurized, thereby reliquefied and returned to the tank 28 via a return line 32. The die 10 stocked with dry ice pellets is detached from the pressing cylinder 2 of the pelletizing device 1 and brought to the separating means 26, in which any protruding dry ice pieces are cut off. The die 10, which is thus stocked with dry ice pellets of a precisely defined geometry, is then used by the application means 27 as a magazine for dry ice pellets and for this purpose is inserted into a magazine receiver 33 of the application means 27.

The application means 27 is a means, for example of a pistol-like design, that is equipped with mechanical pushing means, for example with elongate needles, which are arranged so as to be axially movable within the application device in such a manner that they eject the dry ice pellets present in the leadthroughs 16 individually or in groups, one after the other or all at the same time. Upon ejection, the dry ice pellets are preferably brought directly to their place of use, which is, for example, a product to be cooled, in particular a food product. For example, this is a piece of meat into which dry ice pellets are filled, for the purpose of cooling, into openings or pockets previously made in the piece of meat.

The die 10, now emptied, is returned to the pelletizing device 1 and restocked with dry ice pellets, as indicated by the arrow 34. In the system 25 shown here for producing and applying dry ice pellets, both the carbon dioxide gas that occurs during pellet production and the die 10 are recirculated and reused. Instead of the die 10, another die, for example the die 20, may also be used in such a system.

### LIST OF REFERENCES

1 pelletizing device
2 pressing cylinder
3 piston
4 end
5 opening
6 piston rod
7 inlet
8 outlet
9 end
10 die
11 front portion
12 threaded hole
13
14 inner end (of the die)
15 outer end (of the die)
16 leadthrough
17 longitudinal axis
18 central leadthrough
19 hole
20 die
21 leadthrough
22 hole
23 sealing ring
24
25 system
26 separating means
27 application means
28 tank
29 means for reliquefying
30 supply line
31 gas line
32 return line
33 magazine receiver
34 arrow

1. A device for producing and transporting dry ice pellets, comprising:
a pelletizing device, which has a pressing cylinder comprising an inlet for supplying liquid carbon dioxide and a gas outlet for discharging carbon dioxide gas, a piston accommodated in a longitudinally movable manner in the pressing cylinder, and a die arranged at an end of the pressing cylinder and having leadthroughs aligned parallel to a longitudinal axis of the die;
wherein the die is separably connected to the pressing cylinder and the length and the diameters of the leadthroughs correspond to the length and diameters of dry ice pellets to be produced.

2. The device as claimed in claim 1, wherein there is assigned to the die a separating means for removing dry ice strands protruding from an end of the die.

3. The device as claimed in claim 1, wherein the pelletizing device has a means for automatically inserting and fixing the die on the pressing cylinder.

4. The device as claimed in claim 1, wherein six to one hundred leadthroughs are provided in the die.

5. The device as claimed in claim 1, wherein the leadthroughs are arranged in a rotationally symmetrical manner around a central axis of the die.

6. The device as claimed in claim 1, wherein the leadthroughs extend within the die in parallel rows that are offset from one another.

7. The device as claimed in claim 1, wherein the leadthroughs each have a length of at least 50 mm and a diameter of at least 5 mm.

8. The device as claimed in claim 1, wherein the gas outlet is connected to a means for reliquefying carbon dioxide gas produced in the pressing cylinder upon expansion of liquid carbon dioxide.

9. A system for producing, transporting and applying dry ice pellets, comprising a device as claimed in claim 1 for producing conditioned dry ice pellets within the die, and comprising a means for applying dry ice pellets, in which the die can be used as a magazine for storing and supplying dry ice pellets.

10. A method for producing, transporting and applying dry ice pellets, in which
dry ice pellets are produced in a die of a pelletizing means,
the die stocked with dry ice pellets is separated from the pelletizing means and brought, as a magazine for dry ice pellets, to a means for applying dry ice pellets, and
the dry ice pellets are applied, by the application means to their intended location.

11. The device as claimed in claim 4, wherein eight to eighty leadthroughs are provided in the die.

12. The device as claimed in claim 7, wherein the leadthroughs each have a length of at least 100 mm and a diameter of at least 10 mm.
